(19) United States
(12) Patent Application Publication
(10) Pub. No.: US 2005/0227006 A1
(43) Pub. Date: Oct. 13, 2005

(54) METHODS FOR PREPARING AN IMAGED COMPOSITE

(76) Inventor: Ronald H. Segall, Morrisville, NC (US)

Correspondence Address: WHITE & CASE LLP;PATENT DEPARTMENT, 1155 AVENUE OF THE AMERICAS, NEW YORK, NY, 10036, US

(21) Appl. No.: 10/709,046

(22) Filed: Apr. 8, 2004

(51) Int. Cl. B05D 5/00

(52) U.S. Cl. 427/256; 427/407.1

(57) ABSTRACT

A method for preparing an imaged composite by applying a layer of a gel coat composition to at least one surface of a substrate comprising a composite material, curing the gel coat composition, and then transferring a sublimatable dye to the cured gel coat is disclosed. The gel coat composition can be cured thermally, via radiation, or by the addition of a catalyst. The sublimation dye design can be printed on a transfer sheet and then transferred to the coated composite by the application of heat and pressure.

### BACKGROUND OF INVENTION

1. Field of the Invention

The present invention is directed to the field of decorative coatings. More specifically, the present invention is directed to methods of preparing imaged articles by applying a sublimation dye to a substrate surface comprising a composite material which is covered with a gel coat layer. The present invention has particular application to the decorative art industries.

2. Background of the Invention

There is a discernible and growing market demand, particularly in the decorative arts industry, for decorated substrates that can be imaged to satisfy a manufacturing requirement or individual preference. Such substrates may include, but are not limited to glass, plastic, metal, canvas and composite materials. It is generally known that certain substrates can be decorated by applying a transfer sheet printed with a selected dye design to a substrate, and by the application of heat and pressure, transferring the decoration from the transfer sheet to the surface of the substrate. It is also known that by using sublimation dyes which vaporize when heated, the decoration can be made to penetrate or bleed into the body of the substrate.

However, the surfaces of certain materials such as composites are not as receptive as other substances, such as paper, to the sublimation of images directly onto their surfaces. Decorative elements imaged directly on these types of composite substrates are prone to abrasion and wear. In addition, exposure of an imaged object to sunlight or UV-light can cause the sublimation dyes to fade, thereby reducing the visual attraction of the object.

U.S. Pat. No. 6,596,116 discloses a process for transferring a decorative sublimation dye design formed on a transfer sheet to a continuous laminate by applying a sheet of cellulose web material impregnated with a thermosetting resin to a surface of a backer sheet.

U.S. Pat. No. 6,300,279 discloses a process of transferring a decorative sublimation dye design formed on a transfer sheet to a wood substrate by applying a sheet of cellulose web material impregnated with a thermosetting resin to at least one surface of a wood substrate.

U.S. published patent application No. 2004/0038036 discloses a method for preparing a recoatable surface on a substrate. The recoatable surface is formed by applying a base coat composition comprising polyol acrylate and epoxy acrylate monomers to a substrate and curing the base coat. The cured base coat is receptive to subsequent imaging using a dye sublimation technique.

Notwithstanding these advancements in the field, there is a continuing need for new methods of preparing imaged decorative articles which can be used in household, commercial and outdoor settings. In this regard, it has not been previously known that the imaging of composite materials with sublimation dyes is unexpectedly improved when the surface of the composite material is coated with a cured gel coat layer.

### SUMMARY OF INVENTION

It has been surprisingly discovered that articles or substrates comprising a composite material which have been coated with a gel coat layer can be imaged with sublimation dyes to obtain an unexpected improvement in the imaged article. The present invention is directed to a method for applying a gel coat composition to at least one surface of a substrate comprising a composite material, curing the gel coat composition and then transferring a sublimatable dye to the cured gel coat to obtain an imaged composite. The claimed invention provides a way of recycling by-products, such as manufacturing waste materials, by incorporating the by-product into the composite during its preparation. For example, the composite material can include fillers such as stone, wood, and plastics which would otherwise be disposed of in a landfill. Without limitation, the waste products or other components of the composite can be in any form, such as grounds, particulates, and fibers. In addition, waste products such as coffee grounds and plant fibers can be used in the composite as part of a “green” manufacturing process to provide a particular decorative appearance on the surface of the composite.

Advantageously, the claimed process provides imaged articles which have excellent abrasive and solvent resistance, toughness and durability, and strong craze resistance. The claimed invention can be used to prepare waterproof and water-resistant imaged products, such as tiles, shower surrounds, bathroom fixtures, and vanities, as well as furniture items such as tables, counters, kitchen back splashes, and fireplace surrounds.

In the present invention, the expression “gel coat composition” refers to the gel coat material before it has been cured. The expression “gel coat” or “gel coat layer” refer to the cured gel coat composition.

The gel coat composition is defined in the present invention as any viscous or semi-viscous resin material which cures to form a stable and durable coating that is receptive to subsequent sublimation dye imaging. The gel coat composition penetrates and tightly bonds with the surface of the substrate after curing. In one embodiment of the invention, the gel coat is comprised of one or more crosslinkable components. The one or more crosslinkable components of the gel coat may cross-link with each other or with the composite material during curing, thereby forming an especially tough and durable finish.

In one embodiment, the gel coat composition further comprises an unsaturated polyester resin, styrene monomer and methyl methacrylate. For example, the gel coat composition may comprise 32-62% unsaturated polyester resin, 28-48% styrene monomer, and 2-14% methyl methacrylate. In another embodiment, the gel coat composition may comprise an unsaturated polyester resin in the range of 42-52%.

The curing step may be conducted at any convenient or appropriate temperature. A temperature in the range between 50° F.-750° F. is typical for curing. The gel coat composition may be cured using any appropriate means, such as thermal-curing or radiation-curing.

The gel coat composition may optionally comprise a catalyst that accelerates curing of the gel coat composition, for example, to reduce cycle time and increase the cross-linking of the gel coat components. The gel coat composition may be pigmented such that a particular color is obtained, or it may be unpigmented and the composite visible underneath the cured gel coat. The thickness of the cured gel coat will vary based upon individual requirements. In general, the thickness of the cured gel coat will be in range of about 1 mil to about 100 mil, such as in the range of 10-25 mils. The durability of the gel coat protects the surface of the article from damage due to wear and exposure.

The substrate for the present invention will typically be a composite material, such as a filler suspended in a matrix binder. Without limitation, examples of fillers are fibers, particulates, fabrics and mixtures thereof, and examples of matrices are canvas, ceramic, cement, glass, metal, plastic and wood. Further examples of filler/matrix composites are known to those of skill in the art. In particular embodiments, the composite material is comprised of a polymeric matrix such as a thermoset or thermoplastic resin. An example of such a composite is a polyester resin matrix reinforced with glass fibers. Additional examples of composites suitable for use in the present invention are synthetic marbles and gypsum cements.

Although the cured gel coat provides a stable surface to the imaged composite, the imaged composite can optionally be covered with a top coat to provide added protection to the imaged article. The top coat can be any material which protects colors, or enhances the appearance of the imaged composite. Examples of top coats are polyester, epoxy, conversion lacquer, waterborne, nitrocellulose, urethane, acrylic, paint, shellac, varnish, enamel, synthetic penetrating oil, nitrocellulose transparent lacquer, acrylic transparent lacquer, acrylic transparent latex, post-catalyzed conversion varnish, polyester, and polyurethane. The top coat can be transparent or translucent, and the thickness of the top coat will vary depending on the particular article. For example, the thickness of the top coat can be in the range of about 0.1 mils to 10 mils. The step of applying a top coat can be repeated, if desired.

### DETAILED DESCRIPTION

As previously mentioned, the gel coat is any viscous or semi-viscous resin material which cures to form a stable and durable coating receptive to subsequent sublimation dye imaging. The gel coat composition can contain any kind of components, such as organic, inorganic, or polymeric materials, provided that the gel coat composition can be cured and imaged. The curing will typically be performed at conventional (room) temperatures or at elevated temperatures. A gel coat composition comprising an unsaturated polyester resin, styrene monomer, and methyl methacrylate is one example of a gel coat composition which can be used to provide a suitable cured surface for imaging. In one embodiment, a gel coat composition having 32-62% unsaturated polyester resin, 28-48% styrene monomer and 2-14% methyl methacrylate can be used to prepare an article in accordance with the claimed method. In an alternative embodiment, a gel coat composition comprising a polyester resin in the range of 42-52% can be used in the present invention.

In addition to any curing or cross-linking components, the gel coat composition can contain inerts or fillers, such as solvents or pigments, provided that any such materials do not interfere with the process of obtaining a gel coat which is receptive to the application of a sublimation dye. It is envisioned that for most composites, one application of a gel coat composition and one curing step will generally suffice to provide a suitable surface for the sublimatable dye design. Nevertheless, in certain embodiments, it may be desirable to repeat the gel coating and curing steps to build up a particular thickness for the gel coat.

The gel coat composition can be applied to the composite using any convenient means. For example, the gel coat composition can be brushed or sprayed onto the composite, or the composite can be dipped into the gel coat composition. Alternatively, a mold can be coated with the gel coat composition and the composite placed into the coated mold. A composite mixture which sets to form a solid material, can also be poured into the coated mold and allowed to harden in the mold. If necessary, heat and/or pressure can be applied to the gel coat composition prior to or during curing to ensure adhesion of the gel coat to the composite.

The gel coat composition can be cured using appropriate means, which will be specific to the gel coat composition selected. For example, certain composites can be cured by exposure to radiation such as UV, while other gel coat materials can be cured thermally in an oven. The coated article can also be passed through a press or rollers during curing to ensure adhesion of the gel coat layer to the article.

The gel coat composition may optionally contain a catalyst to accelerate curing, especially if the curing would take a significant amount of time. The particular catalyst selected, and the amount of catalyst used, will depend upon the gel coat composition. For example, a methyl ethyl ketone peroxide catalyst can be used to accelerate curing of a polymeric monomer. The catalyst will generally be necessary only in small quantities, such as 1-5%.

Gel coat compositions can be custom prepared for each particular application, or they can be obtained commercially. A vendor of commercially available gel coat compositions which are suitable for use in the present invention is HK Research Corporation in Hickory, N.C.

The finish obtained on the cured gel coat will depend on its composition or cure conditions, and can include high gloss, glossy, matte, or other types of finishes. In particular applications, such as bathroom shower floor tiles, it may be desirable for the cured gel coat to have a non-smooth finish, such as a pebbly surface, which is nevertheless still receptive to being imaged by the sublimation dye.

Because the cured gel coat has excellent adhesion to the composite, a separate fill coat or sanding step applied to the composite to provide a smooth or more receptive base surface will generally be unnecessary. For example, the gel coat material can be applied to a composite which has not been mechanically smoothed or planed, and which has small imperfections on its surface. In this manner, manufacturing costs are reduced by elimination of these additional processing steps. However, if desired, a fill coat or other processing step can be applied to the substrate before application of the gel coat composition to provide a particularly desired finish or effect.

The composites used in the present invention can have any type of construction or internal structure such as fibrous, particulate or laminar type. The color of the composite will depend on its components and in certain embodiments, a pigment may be added to the composite to provide a particular coloration or undertone.

Polymeric matrix composites are generally the most common types of composites, and are one example of substrates which can be used in the present invention. An example of a polymeric matrix composite is a polyester resin reinforced with low-strength glass fibers. In order to manufacture such a composite, the fibers are first impregnated with the resin. The fibers are then placed in a matrix and formed into the desired shape. After the composite has been formed, the article is cured and finished.

In another embodiment of the invention, synthetic marbles and gypsum cements can be used as the substrates for the coating process. Such materials are commercially available from several vendors, and include Hydrocal® A-11 and FGR-95 gypsum cements available from the U.S. Gypsum Company, Chicago, Ill. These gypsum cements generally contain Plaster of Paris, Portland cement and/or crystalline silica. Composites containing aluminum tri-hydrate and chopped fiberglass (sold as Dura Stone® by Arizona Cultured Stone Products) are further examples of composites that can be used in the present invention. Other examples of composites are generally known to those of skill in the art.

The cured gel coat is imaged with a sublimation dye design to provide the imaged article. Sublimation dye designs may be applied to the cured gel coat using techniques known in the art. For example, U.S. Pat. No. 4,354,851; U.S. Pat. No. 4,908,345; and U.S. Pat. No. 3,860,388 disclose methods for producing decorated substrates using dye sublimation techniques. The transfer sheets containing the sublimatable ink and the design to be imaged may also be prepared using known techniques. Typical conditions for the transfer of a sublimation dye design from a transfer sheet are 300-500° F. and 20-60 psi, and typical contact times between the transfer sheet and the composite during the dye transfer step may range from 5 seconds to 300 seconds. For certain applications, conditions outside of these ranges may be found to be more appropriate. The imaging step can be repeated in order to apply a plurality of designs to the gel coat.

The imaged dye design does not need to extend over the entire surface of the article and, therefore, unimaged areas can remain transparent and show the natural surface and coloration of the composite. In addition, the gel coat composition does not need to be applied to the entire article, and depending upon the desired effect and appearance, the gel coat composition can be applied to only a pre-selected portion of the article.

The cured gel coat permits the application and adhesion of an optional top coat. The top coat can be any type of material which protects, colors, or enhances the surface appearance of the article. For example, the top coat can be a tinted polyester, epoxy, conversion lacquer, nitrocellulose, urethane, acrylic, paint, shellac, varnish, enamel, organic-based, or water-based material.

Additional examples of materials that can be applied as top coats are: synthetic penetrating oils; nitrocellulose transparent lacquers; acrylic transparent lacquers and latexes; and post catalyzed conversion varnishes, polyesters, and polyurethanes. These top coats can be applied and cured in any conventional manner, such as at ambient temperature, low bake or high bake temperatures, radiation, or UV curing. Although not required, the top coat material can optionally comprise compounds such as UV-stabilizers which inhibit fading of the underlying sublimated dye image.

The color of any top coat applied to the imaged article will, of course, depend upon the particular application. For example, if a light-colored ceramic composite is desired, such as bathroom tile, no top coat may need to be applied to a gel-coated and imaged light-colored composite. Alternatively, if a darker accent color is desired, after curing and imaging, a deeply pigmented stain can be applied to color the ceramic article and thereby obtain a darker tile. In certain instances, the color of the top coat may be sufficiently intense so as to penetrate the gel coat and reach the surface of the underlying substrate. As a result, it is possible to adjust the final coloration or appearance of the imaged article to satisfy limitless commercial applications and personal preferences.

The gel coat and any optional top coat may be of any thickness, which would depend upon the amount of the particular coating material applied and the porosity of the composite. For example, wooden based composites which are very porous may require an application of a thicker gel coat layer, such as in the range of about 10-100 mils. Less porous materials such as polymeric composites may require a gel coat which is only 10-25 mils thick. In practice, the thickness of the gel coat and any optional top coat may independently range from 0.1 mils to 100 mils.

Advantageously, only one gel coating step and one top coating step (if used) are necessary with the claimed invention. However, as previously mentioned, for certain applications, it may be advantageous to apply a plurality of top coats, a plurality of gel coats, or both, to obtain a particular coating thickness or property.

The claimed method will now be further described with reference to the Example below, in which a synthetic marble composite is prepared and coated in accordance with the present invention.

### EXAMPLE

A mold is coated with a thin layer of a wax as a release agent. A gel coat composition comprising 42-52% unsaturated polyester resin, 38% styrene monomer, and 7% methyl methacrylate (available under the trade name of Ultra® from HK Research Corp., Hickory, N.C.) is treated with a methyl ethyl ketone peroxide catalyst (2% by weight). The treated gel coat composition is sprayed into the mold to form a layer about 25 mils thick.

While the mold is being prepared, a synthetic marble substrate is prepared according to the following formula:

| Material | Quantity |
|---|---|
| Synthetic marble composition* | 100 lbs |
| Water | 30 lbs |
| Chopped coated fiberglass | 5 lbs |

*Sold by Arizona Cultured Stone Products, Inc. under the trade name of Hydrocal Dura Stone ® and having the following composition: aluminum trihydrate (50-80%); titanium dioxide (pigment, 1.0%); chopped fiberglass (8-25%)

The components of the synthetic marble substrate are mixed, and allowed to soak for 4 minutes to allow for deairing. After stirring for 6 minutes, the mixture is poured into the prepared mold. The gel coat cures while the synthetic marble substrate solidifies, and the total curing time and solidification time will typically be about 45-60 minutes. The catalyst allows the gel coat composition to cure at ambient temperature (75-80° F.) without the need for additional means of curing.

After curing, the article is removed from the mold, and a dye transfer sheet is applied to the surface of the cured gel coat. The dye design is transferred to the cured gel coat in about 1 minute by application of 50-150 psi pressure at a temperature of 325-400° F.

Numerous modifications and variations of the present invention are possible in light of the above teachings, and therefore, within the scope of the appended claims, the invention may be practiced otherwise than as particularly described.

The components of the synthetic marble substrate are mixed, and allowed to soak for 4 minutes to allow for deairing. After stirring for 6 minutes, the mixture is poured into the prepared mold. The gel coat cures while the synthetic marble substrate solidifies, and the total curing time and solidification time will typically be about 45-60 minutes. The catalyst allows the gel coat composition to cure at ambient temperature (75-80° F.) without the need for additional means of curing.

After curing, the article is removed from the mold, and a dye transfer sheet is applied to the surface of the cured gel coat. The dye design is transferred to the cured gel coat in about 1 minute by application of 50-150 psi pressure at a temperature of 325-400° F.

Numerous modifications and variations of the present invention are possible in light of the above teachings, and therefore, within the scope of the appended claims, the invention may be practiced otherwise than as particularly described.

1. A method of preparing an imaged composite, the method comprising the steps of:
(a) applying a layer of a gel coat composition to at least one surface of a substrate comprising a composite material;
(b) curing the gel coat composition; and
(c) transferring a sublimatable dye to the cured gel coat to obtain the imaged composite.

2. The method according to claim 1, wherein the gel coat composition comprises one or more crosslinkable components.

3. The method according to claim 2, wherein the one or more crosslinkable components cross-link with the composite material or with each other during curing.

4. The method according to claim 1, wherein the curing step is conducted at a temperature in the range of about 50° F.-750° F.

5. The method according to claim 1, wherein the gel coat composition comprises unsaturated polyester resin, styrene monomer and methyl methacrylate.

6. The method according to claim 5, wherein the gel coat composition comprises 32-62% unsaturated polyester resin, 28-48% styrene monomer and 2-14% methyl methacrylate.

7. The method according to claim 1, wherein the gel coat composition comprises an unsaturated polyester resin in the range of 42-52%.

8. The method according to claim 1, wherein the gel coat optionally comprises a catalyst that accelerates curing of the gel coat composition.

9. The method according to claim 1, wherein the gel coat composition is pigmented or unpigmented.

10. The method according to claim 1, wherein the thickness of the cured gel coat is in the range of about 1 mil to about 100 mil.

11. The method according to claim 10, wherein the thickness of the cured gel coat is in the range of about 10 mil to about 25 mil.

12. The method according to claim 1, wherein the gel coat is thermally-cured or cured by radiation.

13. The method according to claim 1, wherein the composite material comprises a filler and a matrix.

14. The method according to claim 13, wherein the filler comprises a material selected from the group consisting of fibers, particulates, fabrics and mixtures thereof.

15. The method according to claim 13, wherein the matrix comprises of a material selected from the group consisting of canvas, ceramic, cement, glass, metal, plastic, and wood.

16. The method according to claim 13, wherein the matrix comprises a polymeric resin matrix.

17. The method according to claim 16, wherein the polymeric resin matrix comprises a thermoset or thermoplastic resin.

18. The method according to claim 16, wherein the polyester resin matrix is reinforced with glass fiber.

19. The method according to claim 13, wherein the composite comprises a gypsum cement or synthetic marble.

20. The method according to claim 1, further comprising the step of applying a top coat onto the imaged composite.

21. The method according to claim 20, wherein the top coat is transparent or translucent.

22. The method according to claim 20, wherein the thickness of the top coat is in the range of about 0.1 mils to 10 mils.

23. The method according to claim 20, wherein the top coat comprises a material selected from the group consisting of a polyester, epoxy, conversion lacquer, waterborne, nitrocellulose, urethane, acrylic, paint, shellac, varnish, enamel, synthetic penetrating oil, nitrocellulose transparent lacquer, acrylic transparent lacquer, acrylic transparent latex, post-catalyzed conversion varnish, polyester, and polyurethane.

24. The method according to claim 20, wherein the step of applying a top coat is repeated.

25. An article prepared according to any one of claims 1-24.
